(19) United States
(12) Patent Application Publication
(10) Pub. No.: US 2026/0253146 A1
(43) Pub. Date: Aug. 27, 2026

(54) AUTOMATIC BANK RECONCILIATION SYSTEMS AND METHODS

(71) Applicant: eUnify Central, LLC, Chandler, AZ (US)

(72) Inventors: Steve SERRA, Gilbert, AZ (US); Vasyl IEMELIANOV, Queen Creek, AZ (US)

(21) Appl. No.: 19/063,096

(22) Filed: Feb. 25, 2025

(51) Int. Cl. G06Q 40/12

(52) U.S. Cl. CPC G06Q 40/12

(57) ABSTRACT

An automated bank reconciliation method includes, during a reconciliation period, daily receiving transaction information from a bank and matching it with accounting transactions on a general ledger. The method also includes, at an end of the reconciliation period, receiving a bank statement, retrieving a statement ending date and balance, accessing all bank statement transactions and comparing them with the transaction information received daily, comparing and matching the bank statement transactions with the accounting transactions from the general ledger and aggregating them into total matched debits and total matched credits, determining a matched-based ending balance by adding total matched credits to and subtracting total matched debits from a starting balance, comparing the matched-based ending balance with the bank statement ending balance, creating a bank reconciliation record and automatically posting it if the ending balances are equal, and sending a notification indicating whether the bank reconciliation record has been matched and posted.

### TECHNICAL FIELD

This document relates generally to bank reconciliation systems and methods, and more specifically to automatic bank reconciliation systems and methods.

### BACKGROUND

Companies maintain internal accounting records as a routine part of doing business. These internal accounting records are reconciled with bank transactions in a process called bank reconciliation on a regular basis (e.g., monthly). Each transaction in the internal accounting records is matched to a bank transaction and vice versa. Any discrepancy between the transactions and the ending balances needs to be accounted for so that the two systems (bank records and accounting records) are reconciled. Bank reconciliation contributes to accurate internal accounting records and can help identify errors (in the internal accounting records or at the bank) or even fraud.

However, bank reconciliation can be a time-consuming exercise. In many cases, companies have multiple bank accounts (with one bank or with multiple banks), which further complicates the process. Moreover, even during bank reconciliation, a bad actor may take steps to conceal fraud. Smaller companies, for example, may not be able to utilize accounting controls, such as separation of duties, to prevent such fraud.

### SUMMARY

Aspects of this disclosure relate to a method of automated bank reconciliation of a reconciliation period for an entity. In some embodiments, the method includes, during the reconciliation period, daily receiving, at a server, transaction information from a bank over a network. In some embodiments, the transaction information is associated with an account of the entity at the bank. In some embodiments, the method includes matching the transaction information with accounting transactions on a general ledger of the entity stored on the server. In some embodiments, the method includes, at an end of the reconciliation period, receiving, at the server, a bank statement from the bank over the network. In some embodiments, the bank statement is associated with the account of the entity at the bank and is associated with the reconciliation period. In some embodiments, the method includes, in response to receiving the bank statement, retrieving a statement ending date and an ending balance on the statement ending date from the bank statement. In some embodiments, the method includes accessing all transactions from the bank statement associated with the reconciliation period, comparing the transactions from the bank statement with the transaction information received daily during the reconciliation period to check whether manipulation of the transaction information received daily has occurred, accessing all accounting transactions from the general ledger of the entity associated with the reconciliation period, comparing the transactions from the bank statement with the accounting transactions from the general ledger of the entity and matching transactions from the bank statement to accounting transactions from the general ledger of the entity, and aggregating the matched transactions into total matched debits and total matched credits. In some embodiments, the total matched debits include a dollar amount and a number of matched debit transactions and the total matched credits include a dollar amount and a number of matched credit transactions. In some embodiments, the method includes determining a matched-based ending balance by adding the dollar amount of the total matched credits to and subtracting the dollar amount of the total matched debits from a bank reconciliation starting balance. In some embodiments, the bank reconciliation starting balance is an ending balance from a prior reconciliation period. In some embodiments, the method includes comparing the matched-based ending balance with the ending balance from the bank statement and creating a bank reconciliation record that includes the bank reconciliation starting balance, the total matched debits, the total matched credits, the match-based ending balance, and the ending balance from the bank statement. In some embodiments, the method includes automatically posting the bank reconciliation record if the matched-based ending balance is equal to the ending balance from the bank statement and sending a notification to an entity electronic device. In some embodiments, the notification indicates whether the bank reconciliation record has been matched and posted.

Particular implementations may include one or more of the following features. In some embodiments, the method also includes, before retrieving the statement ending date and the ending balance on the statement ending date from the bank statement, checking whether reconciliation for the reconciliation period has already been completed. In some embodiments, the method also includes, before retrieving the statement ending date and the ending balance on the statement ending date from the bank statement, checking whether reconciliation for a prior reconciliation period has already been completed. In some embodiments, the method also includes identifying offsetting entries in the general ledger and clearing the identified offsetting entries. In some embodiments, the method also includes identifying interest credited by the bank and creating an interest journal entry in the general ledger. In some embodiments, the network is the internet. In some embodiments, the method also includes receiving user input over the network from the entity electronic device if the matched-based ending balance is not equal to the ending balance from the bank statement.

Aspects of this disclosure relate to a method of automated bank reconciliation of a reconciliation period for an entity. In some embodiments, the method includes receiving a bank statement from a bank. In some embodiments, the bank statement is associated with an account of the entity at the bank. In some embodiments, the method includes, in response to receiving the bank statement, retrieving a statement ending date and an ending balance on the statement ending date from the bank statement. In some embodiments, the method includes matching transactions from the bank statement associated with the reconciliation period to accounting transactions from a general ledger of the entity associated with the reconciliation period, aggregating the matched transactions into total matched debits and total matched credits, and determining a matched-based ending balance by adding the total matched credits to and subtracting the total matched debits from a bank reconciliation starting balance. In some embodiments, the bank reconciliation starting balance is an ending balance from a prior reconciliation period. In some embodiments, the method includes comparing the matched-based ending balance with the ending balance on the statement ending date, creating a bank reconciliation record including the bank reconciliation starting balance, the total matched debits, the total matched credits, the match-based ending balance, and the ending balance on the statement ending date, and sending a notification to an entity electronic device. In some embodiments, the notification indicates whether the matched-based ending balance is equal to the ending balance on the statement ending date.

Particular implementations may include one or more of the following features. In some embodiments, the method also includes checking whether reconciliation for the reconciliation period has already been completed. In some embodiments, the method also includes checking whether reconciliation for a prior reconciliation period has already been completed. In some embodiments, the method also includes identifying offsetting entries in the general ledger and clearing the identified offsetting entries. In some embodiments, the method also includes identifying interest credited by the bank and creating an interest journal entry in the general ledger. In some embodiments, the method also includes automatically posting the bank reconciliation record if the matched-based ending balance is equal to the ending balance on the statement ending date. In some embodiments, the method also includes receiving user input over the network from the entity electronic device if the matched-based ending balance is not equal to the ending balance on the statement ending date.

Aspects of this disclosure relate to a system for automated bank reconciliation of a reconciliation period for an entity. In some embodiments, the system includes a bank reconciliation server configured to store a general ledger of the entity and a server associated with a bank. In some embodiments, the bank reconciliation server is configured to communicate with the bank server over a network. In some embodiments, the system includes an entity electronic device operably connected to the bank reconciliation server over the network. In some embodiments, the bank reconciliation server is configured to receive a bank statement from the bank over the network. In some embodiments, the bank statement is associated with an account of the entity at the bank. In some embodiments, the bank reconciliation server is configured to, in response to receiving the bank statement, retrieve a statement ending date and an ending balance on the statement ending date from the bank statement. In some embodiments, the bank reconciliation server is configured to access all transactions from the bank statement associated with the reconciliation period, access all accounting transactions from the general ledger of the entity associated with the reconciliation period, compare the transactions from the bank statement with the accounting transactions from the general ledger of the entity and match transactions from the bank statement to accounting transactions from the general ledger of the entity, and aggregate the matched transactions into total matched debits and total matched credits. In some embodiments, the total matched debits include a dollar amount and a number of matched debit transactions and the total matched credits include a dollar amount and a number of matched credit transactions. In some embodiments, the bank reconciliation server is configured to determine a matched-based ending balance by adding the dollar amount of the total matched credits to and subtracting the dollar amount of the total matched debits from a bank reconciliation starting balance. In some embodiments, the bank reconciliation starting balance is an ending balance from a prior reconciliation period. In some embodiments, the bank reconciliation server is configured to compare the matched-based ending balance with the ending balance from the bank statement, create a bank reconciliation record including the bank reconciliation starting balance, the total matched debits, the total matched credits, the match-based ending balance, and the ending balance from the bank statement, and send a notification to the entity electronic device. In some embodiments, the notification indicates whether the bank reconciliation record has been matched and posted.

Particular implementations may include one or more of the following features. In some embodiments, the entity electronic device is configured to receive user input to enable automatic posting of the bank reconciliation record. In some embodiments, the bank reconciliation server is configured to automatically post the bank reconciliation record if the matched-based ending balance is equal to the ending balance from the bank statement, when automatic posting is enabled. In some embodiments, the entity electronic device is configured to receive user input if the matched-based ending balance is not equal to the ending balance from the bank statement. In some embodiments, the bank reconciliation server is configured to check whether reconciliation for a prior reconciliation period has already been completed. In some embodiments, the network is the internet.

The foregoing and other aspects, features, and advantages will be apparent from the DESCRIPTION and DRAWINGS, and from the CLAIMS.

### BRIEF DESCRIPTION OF THE DRAWINGS

Implementations will hereinafter be described in conjunction with the appended and/or included DRAWINGS, where like designations denote like elements.

FIG. 1 shows a schematic of an automatic bank reconciliation system according to some embodiments.

FIG. 2 shows a schematic of an automatic bank reconciliation system according to some embodiments.

FIG. 3 shows a schematic of a process for automatic daily matching of bank transactions to general ledger entries according to some embodiments.

FIGS. 4A and 4B show a flow chart of a process of automatic bank reconciliation according to some embodiments.

FIG. 5 shows a schematic diagram of computing devices that can be used to perform or implement the embodiments disclosed herein.

### DETAILED DESCRIPTION

Detailed aspects and applications of the disclosure are described below in the following drawings and detailed description of the technology. Unless specifically noted, it is intended that the words and phrases in the specification and the claims be given their plain, ordinary, and accustomed meaning to those of ordinary skill in the applicable arts.

In the following description, and for the purposes of explanation, numerous specific details are set forth in order to provide a thorough understanding of the various aspects of the disclosure. It will be understood, however, by those skilled in the relevant arts, that embodiments of the technology disclosed herein may be practiced without these specific details. It should be noted that there are many different and alternative configurations, devices and technologies to which the disclosed technologies may be applied. The full scope of the technology disclosed herein is not limited to the examples that are described below.

The singular forms “a,” “an,” and “the” include plural referents unless the context clearly dictates otherwise. Thus, for example, reference to “a step” includes reference to one or more of such steps.

The word “exemplary,” “example,” or various forms thereof are used herein to mean serving as an example, instance, or illustration. Any aspect or design described herein as “exemplary” or as an “example” is not necessarily to be construed as preferred or advantageous over other aspects or designs. Furthermore, examples are provided solely for purposes of clarity and understanding and are not meant to limit or restrict the disclosed subject matter or relevant portions of this disclosure in any manner. It is to be appreciated that a myriad of additional or alternate examples of varying scope could have been presented but have been omitted for purposes of brevity.

The term “plurality”, as used herein, means more than one. When a range of values is expressed, another embodiment includes from the one particular value and/or to the other particular value. Similarly, when values are expressed as approximations, by use of the antecedent “about,” it will be understood that the particular value forms another embodiment. All ranges are inclusive and combinable.

Throughout the description and claims of this specification, the words “comprise” and “contain” and variations of the words, for example “comprising” and “comprises,” mean “including but not limited to,” and are not intended to (and do not) exclude other components.

As required, detailed embodiments of the present disclosure are included herein. It is to be understood that the disclosed embodiments are merely exemplary of the invention that may be embodied in various forms. Therefore, specific structural and functional details disclosed herein are not to be interpreted as limits, but merely as a basis for teaching one skilled in the art to employ the present invention. The specific examples below will enable the disclosure to be better understood. However, they are given merely by way of guidance and do not imply any limitation.

The present disclosure may be understood more readily by reference to the following detailed description taken in connection with the accompanying figures and examples, which form a part of this disclosure. It is to be understood that this disclosure is not limited to the specific materials, devices, methods, applications, conditions, or parameters described and/or shown herein, and that the terminology used herein is for the purpose of describing particular embodiments by way of example only and is not intended to be limiting of the claimed inventions.

More specifically, this disclosure, its aspects and embodiments, are not limited to the specific material types, components, methods, or other examples disclosed herein. Many additional material types, components, methods, and procedures known in the art are contemplated for use with particular implementations from this disclosure. Accordingly, for example, although particular implementations are disclosed, such implementations and implementing components may comprise any components, models, types, materials, versions, quantities, and/or the like as is known in the art for such systems and implementing components, consistent with the intended operation.

Companies and associations (e.g., homeowner associations) maintain internal accounting records as a routine part of doing business. These internal accounting records are reconciled with bank transactions in a process called bank reconciliation on a regular basis (e.g., monthly). Each transaction in the internal accounting records is matched to a bank transaction and vice versa. Although each transaction is matched, this matching is not always on a one-to-one basis. For example, one bank transaction may be matched to one accounting transaction, one bank transaction may be matched to multiple accounting records (e.g., when one ACH payment processed at a bank is associated with multiple invoice payments in the accounting system), and/or multiple bank transactions may be matched to one accounting record. Any discrepancy between the transactions and the ending balances needs to be accounted for so that the two systems (bank records and accounting records) are reconciled. Bank reconciliation contributes to accurate internal accounting records and can help identify errors (in the internal accounting records or at the bank) or even fraud. Board members of the companies or associations (or other leaders or interested parties) may rely on these accounting records and bank reconciliations (e.g., to understand the financial condition of the company or association).

However, bank reconciliation can be a time-consuming exercise. In many cases, companies have multiple bank accounts (with one bank or with multiple banks), which further complicates the process. Moreover, even during bank reconciliation, a bad actor may take steps to conceal fraud. Smaller companies, for example, may not be able to utilize accounting controls, such as separation of duties, to prevent such fraud.

Improved systems and methods for performing bank reconciliation are desirable to simplify the process, save time completing bank reconciliation, and better guard against fraud.

The present disclosure relates to improved bank reconciliation systems and methods, and more specifically to automatic bank reconciliation systems and methods. In some embodiments, the system comprises a server at which the bank reconciliation may be completed automatically. The server may have access to a company's internal accounting records (e.g., the general ledger) as well as the company's bank records. For example, the company's general ledger may be stored on the server, and the server may receive the company's bank records over a network (e.g., daily bank information (e.g., in the BAI2 industry standard format), monthly bank statements). The server may be configured to match the bank transactions with transactions in the general ledger, use the matched transactions to determine a matched-based ending balance for a reconciliation period, and compare the matched-based ending balance with an ending balance from a bank statement. If the ending balances are equal, then the records have been reconciled and the server may be configured to automatically post a record of the bank reconciliation. The server may send a notification to an electronic device indicating whether the bank reconciliation record has been posted. If not, user input may be received through the electronic device to complete the bank reconciliation.

In some embodiments, the bank reconciliation systems and methods disclosed herein simplify bank reconciliation. For example, in some embodiments, voided transactions in the general ledger may be automatically matched to each other (e.g., a check and a void of that check) and those offsetting entries cleared. Clearing these offsetting entries in the general ledger results in a clearer, easier to understand bank reconciliation. Another example is when the accounting system pays multiple vendors via ACH. The multiple invoice payments in the accounting system are matched to the one ACH payment processed at the bank.

In some embodiments, the bank reconciliation systems and methods disclosed herein save time in performing bank reconciliation. Employees at the company only need to get involved in a bank reconciliation that cannot be automatically posted, with other bank reconciliation records being completed and posted without any time from a company employee.

In some embodiments, the bank reconciliation systems and methods disclosed herein also help guard against fraud, including bank reconciliation fraud. By providing fully automated bank reconciliations, fewer humans are involved in the reconciliation process, which leads to less fraud. The end user, for example, is less likely to be able to fudge the numbers and cover their tracks. In addition, retrieving a bank statement for a reconciliation period provides a fresh copy of bank transaction data and ensures that daily bank information received during the reconciliation period was not manipulated in an effort to cover a bad actor's fraud. In addition, the automatic bank reconciliation systems and methods help improve separation of duties as an accounting control (especially for companies with small employee count that are unable to implement such an accounting control without automatic bank reconciliation).

Moreover, only those bank reconciliations that are unable to be automatically posted are subject to human review. As such, a higher level of scrutiny may be used for those bank reconciliations (which will be fewer than all bank reconciliations that are completed). The higher level of scrutiny (and the reduced load due to fewer records to review) make it more likely that issues will be found and resolved in a timely manner, thus improving visibility to errors in accounting records. Overall, this results in better, more trustworthy financials for the company, giving a more accurate description of the financial condition to board members and other interested parties. Financial transparency may be increased.

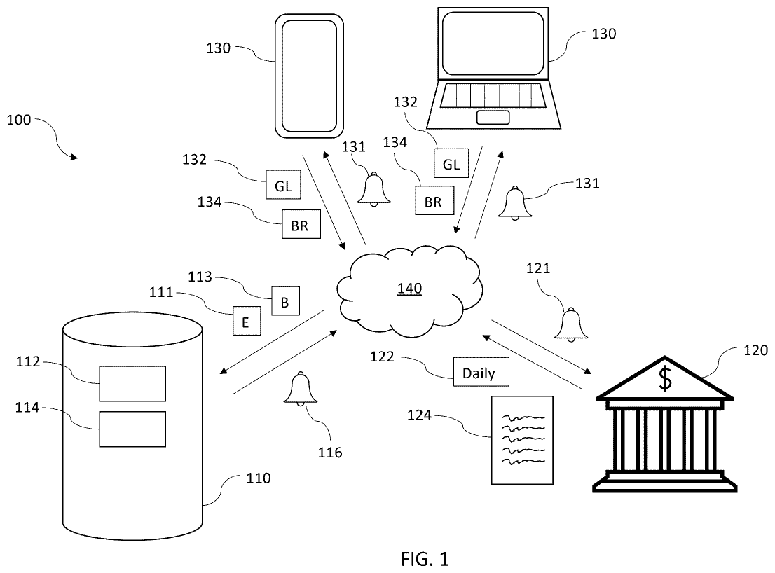

An example system for automatic bank reconciliation (e.g., system 100) is shown, for example, in FIG. 1. The system 100 may include a bank reconciliation server 110, a server 120 associated with a bank, one or more electronic devices 130 associated with an entity (e.g., a company that is using the automatic bank reconciliation system 100), and a network 140 over which bank reconciliation server 110, bank server 120, and entity electronic devices 130 may communicate.

In some embodiments, bank reconciliation server 110 is configured to perform automatic bank reconciliation. Bank reconciliation server 110 may be associated with an entity that provides accounting software for one or more other companies. Although only one bank reconciliation server 110 is shown in FIG. 1, bank reconciliation server 110 may represent one or more bank reconciliation servers 110 associated with the entity that provides accounting software to other companies.

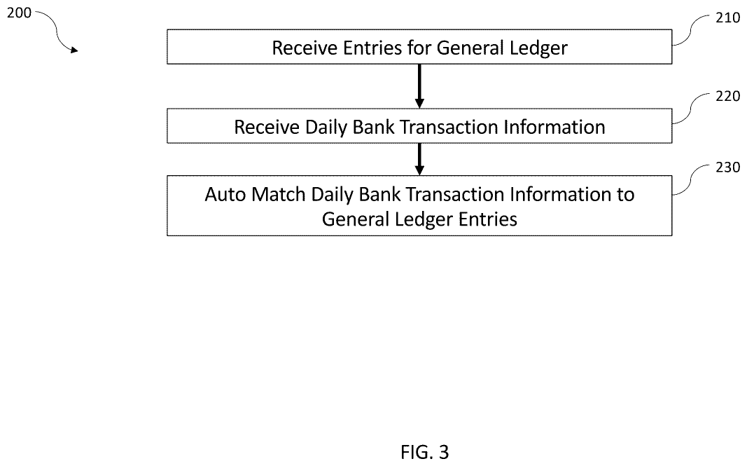

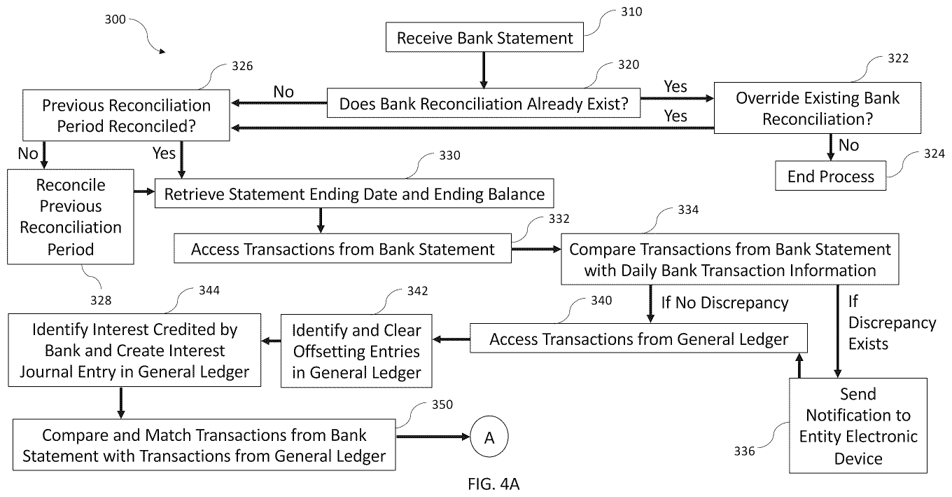

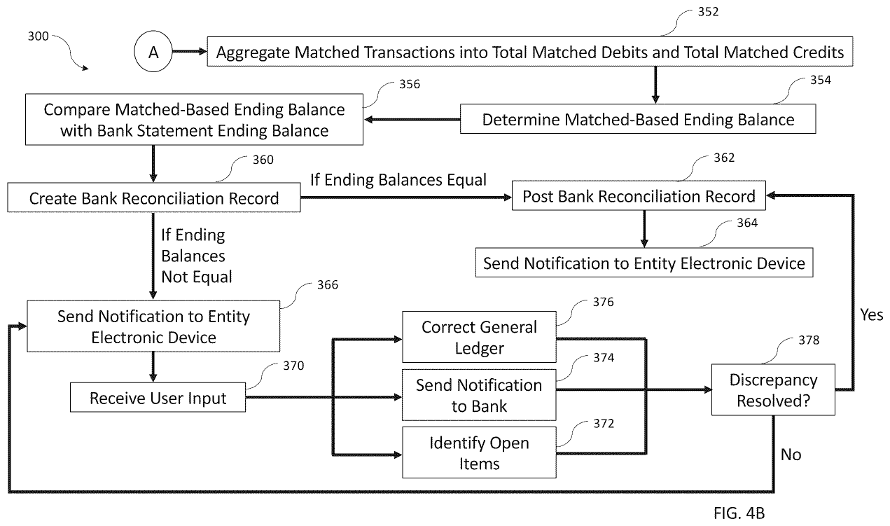

In some embodiments, bank reconciliation server 110 comprises one or more modules that are configured to perform various tasks as part of the automatic bank reconciliation discussed in more detail below. In some embodiments, bank reconciliation server 110 comprises a general ledger module 112 and an automatic bank reconciliation module 114. In some embodiments, general ledger module 112 stores each company's general ledger and includes the software to receive new entries (and/or modify existing entries to correct an error). General ledger module 112 may provide information from the general ledger to bank reconciliation module 114 to allow for the automatic bank reconciliation process to occur. Automatic bank reconciliation module 114 may perform the automatic bank reconciliation discussed below (see FIGS. 3-4B).

As noted above, bank reconciliation server 110 is configured to communicate with bank servers 120 and entity electronic devices 130 over network 140. In some embodiments, bank reconciliation server 110 is configured to receive (over network 140) information 111 from an entity, such as from an entity electronic device 130. Information 111 from an entity may include accounting transactions for general ledger module 112 to be stored on that entity's general ledger, updates to existing entries on general ledger (e.g., to correct an error), feedback on a bank reconciliation (e.g., when the bank reconciliation was unable to be automatically posted) for bank reconciliation module 114 to allow for the bank reconciliation to be completed, or other information (e.g., information about the entity to set up an account, general feedback on the software, etc.).

In some embodiments, bank reconciliation server 110 is configured to receive (over network 140) information 113 from a bank, such as from a bank server 120. Information 113 from a bank may include daily transaction information (e.g., information in the BAI2 industry standard format received daily from bank 120), a monthly bank statement, or other information. In some embodiments, bank reconciliation server 110 may receive information 113 from a bank in response to requesting it (e.g., by accessing the bank's application programming interface (API) and retrieving the information 113 over network 140). In some embodiments, bank reconciliation server 110 may receive information 113 by using a secure file transfer protocol (SFTP) account (e.g., the bank may place the information into an SFTP account, allowing server 110 to receive it over network 140). Any other communication methods (currently existing methods or methods that may arise in the future) in which information is shared between bank reconciliation server 110 and bank server 130 may also be used.

In some embodiments, bank reconciliation server 110 is configured to send notifications 116 over network 140. These notifications 116 may be for an entity (relating to whether a bank reconciliation has been completed and posted, requesting user input to allow for completing a bank reconciliation, etc.) or for a bank (e.g., informing a bank of an error in a bank statement, etc.).

In some embodiments, bank server 120 comprises a server associated with a bank at which one or more entities using system 100 have bank accounts. As noted above, bank server 120 is configured to communicate with bank reconciliation servers 110 and entity electronic devices 130 over network 140. For each account, bank server 120 may send daily transaction information 122 for that bank account. In some embodiments, daily transaction information 122 comprises information in the BAI2 industry standard format. For each account, bank server 120 may also send periodic (e.g., monthly) bank statements 124 for that bank account. Daily transaction information 122 and bank statements 124 may be sent over network 140 to bank reconciliation server 110 and/or entity electronic device 130. Bank server 120 may also receive notifications 121 over network 140, which may originate from bank reconciliation server 110 or entity electronic device 130. Notifications 121 may include notifications relating to an error in daily transaction information 122 or bank statements 124, notifications of fraudulent activity using the bank account, or other notifications.

In some embodiments, entity electronic device 130 comprises any electronic device 130 used for conducting business of the entity and may include the entity's own electronic devices or an employee's electronic devices. Entity electronic device 130 may be any suitable electronic device, such as a laptop or desktop computer, tablet, smartphone, smart watch or any other electronic device. FIG. 1 illustrates both a smartphone and a laptop as example entity electronic devices 130. In some embodiments, entity electronic device 130 comprises a user interface that allows the user to interact with system 100 (e.g., to input information; review notifications, general ledger information, bank records, bank reconciliations, etc.; and perform other operations). The user interface may be one or more of a display screen, a touch screen, one or more buttons, a keyboard, a mouse, or other types of user interfaces. Each entity that uses system 100 may use any number of entity electronic devices 130, and any number of entities may use system 100.

As noted above, entity electronic devices 130 are configured to communicate with bank reconciliation servers 110 and bank servers 120 over network 140. In some embodiments, entity electronic device 130 may be used to input information 132 for the entity's general ledger. This information 132 may be sent over network 140 to bank reconciliation server 110 to update the company's general ledger at general ledger module 112. In some embodiments, entity electronic device 130 may be used to input information 134 relating to the bank reconciliation process (e.g., to complete bank reconciliation that was unable to be completed automatically). This information 134 may be sent over network 140 to bank reconciliation server 110 to facilitate finishing the bank reconciliation process at bank reconciliation module 114. In some embodiments, information 134 may also be sent to bank server 120 (e.g., when information 134 relates to an error in the bank records).

Entity electronic device 130 may also be configured to receive notifications 131 over network 140. Notifications 131 may include notifications relating to whether a bank reconciliation has been completed and posted, requesting user input to allow for completing a bank reconciliation, etc.

Network 140 may take a variety of forms. In some embodiments, network 140 comprises a wireless network, such as a wireless wide area network. For example, network 140 may be the internet. Network 140 may allow bank reconciliation server 110, bank server 120, and entity electronic device 130 to communicate with each other. Entity electronic devices 130 may communicate with bank reconciliation server 110 and/or bank server 120 by accessing a particular website (or websites) on the internet or by using a dedicated app (or apps) for the bank reconciliation system 100. In some embodiments, a single website or app facilitates communication with both bank reconciliation server 110 and bank server 120. In some embodiments, network 140 comprises a wired network.

In some embodiments, a sneaker-net may be used instead of or in addition to network 140. For example, bank transactions may be received by a user instead of the transactions being received directly at the bank reconciliation server 110 from bank server 120. The user may download bank transactions from their bank and save the transactions in a file. Subsequently, the user may upload these transactions into the accounting system (e.g., at bank reconciliation server 110) as bank transactions. In some embodiments, instead of the user downloading transactions from their bank, the user may download bank statements from the bank and system 100 may retrieve individual bank transactions from the bank statement. For example, bank reconciliation server 110 can utilize artificial intelligence and machine learning to retrieve the individual bank transactions from the bank statement. This approach essentially replaces the BAI2 file (discussed below) with information scraped from the bank statement itself. The sneaker-net options discussed in this paragraph may be useful in instances where the user's bank is a non-integrated bank (e.g., its servers are not configured to share information with bank reconciliation server 110 over network 140).

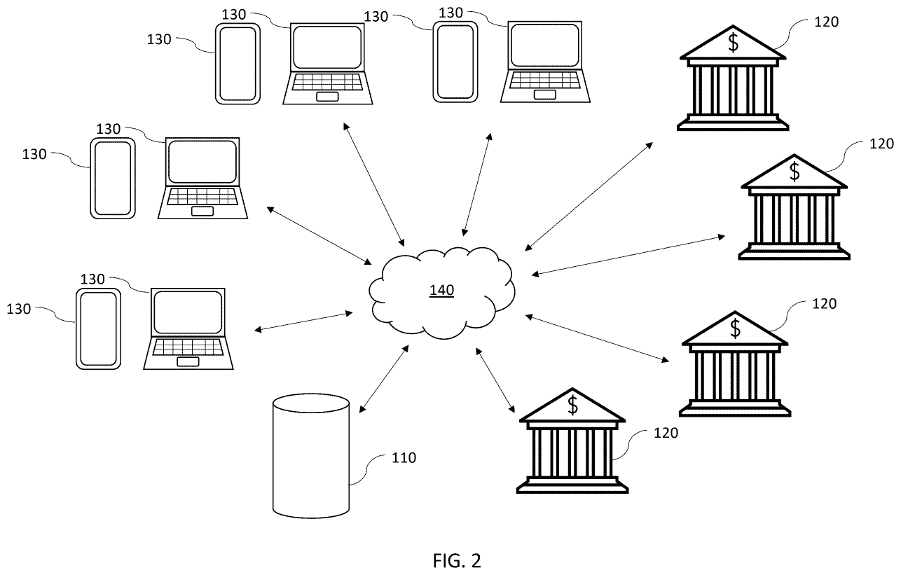

FIG. 1 illustrates the general bank reconciliation system 100 for a single company (with two entity electronic devices 130 shown for illustration) using a single bank (with one bank server 120). However, this is merely for ease of illustration, and the disclosed systems are not limited to such a situation. Multiple companies and/or multiple banks may be a part of system 100. For example, FIG. 2 shows multiple entities (each represented by two entity electronic devices 130 for illustration only, any other number of entity electronic devices 130 may be associated with an entity) and multiple banks (each represented by a bank server 120 for illustration only, other number of bank servers 120 may be associated with a bank). Each entity may have one or multiple bank accounts at a single bank (stored at bank server 120), and each entity may use more than one bank (e.g., one or multiple bank accounts at each of a plurality of banks stored at different bank servers 120). In addition, system 100 may be used by a company (e.g., a management company) that performs work for multiple other companies (e.g., homeowner associations). For example, a management company that provides financial accounting services for multiple associations may be a user of system 100. The management company may use system 100 to process bank reconciliations for multiple associations.

System 100 is able to receive the appropriate information from each bank account so that an entity can reconcile its accounting records with each of its bank accounts. While the process is primarily described below with respect to one bank account, the process can be replicated for entities with multiple accounts and/or banks. The system described above and the method below facilitates efficient automatic bank reconciliation. For example, the communication over network 140 between bank server 120 and bank reconciliation server 110 facilitates efficient automatic bank reconciliation. Bank statement 124 can be provided directly to bank reconciliation server 110, allowing the bank reconciliation process to commence without human involvement.

In some embodiments, system 100 may be used to perform methods of automatic bank reconciliation. In some embodiments, this method includes a method 200 (see FIG. 3) that relates to daily transactions and a method 300 (see FIGS. 4A-4B) that relates to a periodic (e.g., monthly) bank reconciliation. Although FIGS. 3 and 4A-4B show various operations in a particular order, the methods of automatic bank reconciliation disclosed herein are not limited to the operations and order shown in FIGS. 3 and 4A-4B. For example, more or fewer operations may be used as part of methods of automatic bank reconciliation. As one specific example, in some embodiments, only the periodic bank reconciliation method 300 is used (and not the daily transactions method 200). Other variations (with more or fewer operations) are also possible. In some embodiments, the operations may be done in a different order than is shown in FIGS. 3 and 4A-4B.

Daily transactions method 200, in some embodiments, comprises receiving entries for the general ledger at operation 210. For example, an employee of an entity may enter transactions that occurred on a certain day (e.g., checks received from clients, checks written to pay for salaries, direct deposits, etc.) at an entity electronic device 130 using software (e.g., accounting software) on entity electronic device 130. In some embodiments, transactions may also be entered into the general ledger as a result of automated actions rather than user input. For example, interest may be automatically posted in the general ledger. As another example, recurring bank transactions may be automatically posted. This information (whether entered by a user or as a result of automated actions) may be received at bank reconciliation server 110 and stored at general ledger module 112 associated with the entity.

In some embodiments, method 200 comprises receiving daily bank transaction information at operation 220. For example, server 110 may receive daily bank transaction information for any bank accounts of the entity from one or more bank servers 120 over network 140. If the entity has two bank accounts at one bank and four bank accounts at a second bank, for example, server 110 may receive daily bank transaction information for each of these bank accounts over network 140. In some embodiments, the daily bank transaction information may be provided in the BAI2 industry standard format. Another format may be used as an alternative (e.g., any other format agreed upon between a bank and the accounting system provider).

In some embodiments, method 200 comprises automatically matching the daily bank transaction information to the general ledger entries at operation 230. For example, server 110 may compare transactions from general ledger (received at operation 210) with transactions from the bank (received at operation 220). In some embodiments, this comparison may include comparing the dollar amounts of the transactions, whether the transactions are credits or debits, and the total number of transactions for the day. In some embodiments, the comparison includes additional information (e.g., the payee or payor of the transactions). In some embodiments, the comparison includes comparing a date, dollar amount, and type of transaction in both the accounting system and at the bank to determine a match. In some embodiments, the comparison includes comparing a check number (if the transaction is a check). For example, check 123 is created on Jan. 1, 2024 for ABC vendor for $100 but is not cashed until Feb. 5, 2024. Since this is a check payment, the matching uses the check number and amount (and not the date). In some embodiments, a check transaction may also compare payee name if available. This comparison, in some embodiments, can detect check fraud if the payee name differs or if the check amount differs. General ledger transactions are matched to bank transactions based on the comparison (e.g., where dollar amounts are equal).

In some embodiments, any unmatched transactions may be reviewed the following day. A user may provide input (e.g., through entity electronic device 130) to match any unmatched transactions. For example, the bank transaction information received at operation 220 may include six $100 transactions, whereas general ledger module 112 may have received one $600 transaction at operation 210. A user may indicate that these transactions are a match. Over time, method 200 may improve its matching process by using machine learning (e.g., taking into account users' indications of matches). In some embodiments, the matches may be provided with a confidence level score (similar to what is described in more detail below with respect to periodic bank reconciliation method 300).

In some embodiments, method 200 may be completed daily to keep track of an entity's accounting. In addition to this daily accounting, a periodic bank reconciliation may be completed. For example, bank reconciliation may be completed monthly. Thus, method 200 may be completed daily during the reconciliation period (e.g., a particular month), followed by method 300 at the end of the reconciliation period. In some embodiments, method 300 may be used to perform the periodic bank reconciliation.

Referring to FIG. 4A, in some embodiments, method 300 may include receiving a bank statement 124 at operation 310. In some embodiments, bank statement 124 may be received from bank server 120 over network 140. For example, once a period has ended, a bank may prepare a bank statement 124, at which point, bank server 120 may send a copy of bank statement 124 over network 120 to server 110. In some embodiments, receiving bank statement 124 may automatically initiate the process for performing automatic bank reconciliation (e.g., method 300).

In some embodiments, receiving bank statement 124 at operation 310 may be done in a different way than receiving bank statement 124 at server 110 directly from bank server 120. For example, in some embodiments, an entity may receive a copy of bank statement 124 at entity electronic device 130 and then upload it to server 110 over network 140. In some embodiments, an entity may receive a hard copy of bank statement 124. The hard copy of bank statement 124 may be scanned and sent to server 110 over network 140. such that the information on bank statement 124 may be retrieved and used for performing automatic bank reconciliation. In some embodiments, the scan prepares a soft copy (e.g., a PDF) of bank statement 124. The scanner, entity electronic device 130 and/or server 110 may be configured to recognize text and images on the bank statement 124 to facilitate other aspects of method 300. In some embodiments, the scan simply pulls relevant information from bank statement 124 (e.g., starting date, ending date, transaction information (amounts, dates, etc.), starting balance, ending balance, account number, bank identifiers, etc.) without making a soft copy of bank statement 124. This relevant information may be sent to server 110.

Other ways of receiving bank statement 124 are also possible. For example, a bank statement can be: sent from a bank to accounting via integration (e.g., sent from bank server 120 directly to server 110 over network 140); downloaded from a bank (e.g., bank server 120) as a PDF and uploaded to an accounting system (e.g., at server 110) via a webpage or dedicated app, or by emailing; downloaded from a bank (e.g., bank server 120) in another file format (e.g., Excel) and then processed via a webpage or dedicated app to upload the information to server 110; downloaded from a third-party website or app (e.g., Plaid) that provides integration between a bank and another service (e.g., the accounting system on server 110); or scanned from a hardcopy bank statement 124 received in the mail. The foregoing options are examples, but others may also be used.

In some embodiments, operation 310 of receiving a bank statement 124 may be performed at server 110 and includes any of the foregoing options. For example, receiving information from bank statement 124 at server 110 based on a scan is within the scope of receiving a bank statement 124.

In some embodiments, in response to receiving bank statement 124 at operation 310, method 300 proceeds to operation 320, during which it is determined whether bank reconciliation for the relevant period already exists. For example, a user may manually perform bank reconciliation using an entity electronic device 130 and bank reconciliation module 114 of server 110. These bank reconciliations may be saved on server 110 (e.g., at bank reconciliation module 114). Method 300 may include a step (operation 320) of checking for these manual bank reconciliations.

In some embodiments, if server 110 already has a bank reconciliation record for the relevant period, method 300 will wait to proceed with automatic bank reconciliation. In some embodiments, at operation 322, a user may be given the option to override the existing bank reconciliation. For example, server 110 may send a notification to electronic device 130. The notification may indicate that a bank reconciliation record for the period already exists and may give the option of overriding the existing bank reconciliation. If a user declines the option to override the existing bank reconciliation, the process ends at operation 324. In such a scenario, method 300 would begin again at the next reconciliation period (e.g., when another bank statement was received at server 110).

In some embodiments, an existing bank reconciliation may be used as part of method 300, even if the override option is selected. For example, a manual bank reconciliation may be performed during the middle of a month as a way to research transactions that are not automatically matched. As part of this process a user may determine (by way of example) that one bank transaction is matched against six accounting transactions. These mid-month matches may be considered when performing the re-match when the transactions are reprocessed afresh (see discussion of operation 350 below).

If a user chooses the option to override the existing bank reconciliation, the method 300 may proceed to operation 326. In addition, if it is determined at operation 320 that a bank reconciliation for the period does not already exist, method 300 may proceed to operation 326. In some embodiments, at operation 326, it is determined whether the previous reconciliation period (i.e., the period before the current period associated with the received bank statement 124) was reconciled. If not, the previous reconciliation period is reconciled at operation 328. This may be done manually or automatically. For example, a user may upload the previous period's bank statement or (if server 110 already has the previous period's bank statement) prompt server 110 to perform bank reconciliation for the previous period (e.g., through the user interface of an entity electronic device 130).

If it is determined at operation 326 that the previous reconciliation period has been reconciled or after operation 328 has been completed, method 300 proceeds to operation 330. In some embodiments, at operation 330, the statement ending date is retrieved from the bank statement 124. In some embodiments, the ending balance is also retrieved from the bank statement 124. In some embodiments, the ending date is used to look up the ending balance on that date. The ending balance can be retrieved from the bank statement via machine learning/artificial intelligence. In some embodiments, the ending balance may be retrieved from the daily transaction information 122 (e.g., the BAI2 transactions) based on the ending date of the period being reconciled. The ending balance from the bank statement 124 may be the target ending balance for the bank reconciliation.

In some embodiments, at operation 332, all transactions from bank statement 124 are accessed. The transactions include every debit and every credit for the bank account during the bank statement period. In some embodiments, at operation 334, the transactions from bank statement 124 are compared with daily bank transaction information 122 that had been received daily from the bank. This comparison at operation 334 may help reduce fraud. Specifically, if a bad actor had been manipulating the daily bank transaction information 122 during the period after it was received to cover fraudulent activity, bank statement 124 would provide a fresh copy of this daily information by including each transaction from the period as part of the bank statement 124. Comparing the transactions from bank statement 124 to the stored daily transaction information 122 ensures that no manipulation has occurred, thus helping reduce fraud.

If, based on the comparison at operation 334, a discrepancy exists, a notification may be sent to entity electronic device 130 at operation 336 in some embodiments. Such a notification may alert the entity of manipulation to daily transaction information 122, allowing the entity to investigate whether and how any fraudulent activity may be occurring (and resolve any fraudulent activity). In some embodiments, operation 334 may be omitted. For example, the transactions may be retrieved from bank statement 124 without comparison, or the transactions may be retrieved from daily bank transaction information 122 (e.g., BAI2 files or other format) rather than retrieving the information from bank statement 124.

If no discrepancy exists in the comparison performed at operation 334 or after operation 336 has been completed (e.g., a notification has been sent and/or any fraudulent activity discovered and resolved), method 300 may proceed to operation 340. In some embodiments, at operation 340, transactions from the entity's general ledger (stored at general ledger module 112) may be accessed.

In some embodiments, at operation 342, any offsetting entries in the entity's general ledger may be identified. For example, server 110 may look for any entries (e.g., a check) in the general ledger that were later voided. Because a voided check would not appear on the bank statement 124, leaving these offsetting entries in the bank reconciliation process may complicate the process. Accordingly, any identified offsetting entries may be cleared as part of operation 342. Clearing offsetting entries from the general ledger may contribute to a clearer, easier to understand bank reconciliation.

In some embodiments, at operation 344, interest credited by the bank may be identified. This may be accomplished in a variety of ways. For example, daily transaction information 122 may be used to identify interest. In some embodiments, a BAI2 file may be used to identify interest based on certain transaction codes used by the bank to designate interest. In some embodiments, a file equivalent to a BAI2 (but in a different agreed-upon file format) may be used to identify interest based on transaction codes or some other identifiers designated by the bank as denoting interest. As another example, server may review transactions from bank statement 124 for any transactions that are identified as an interest credit as part of a machine learning/artificial intelligence process that is used to read the bank statement.

These interest credits are typically not reflected in the general ledger as the amount is not known until the bank statement is received. Accordingly, in some embodiments, server 110 may add an interest journal entry in the general ledger at general ledger module 112 as part of operation 344 in response to identifying interest credited by the bank. Adding interest journal entries to the general ledger may also contribute to a clearer, easier to understand bank reconciliation.

In some embodiments, at operation 350, server 110 may compare transactions from bank statement 124 with transactions from the general ledger. In some embodiments, this comparison may include comparing the dollar amounts of the transactions, whether the transactions are credits or debits, the date of the transactions, and the total number of transactions for each day. In some embodiments, the comparison includes additional information (e.g., the payee or payor of the transactions). In some embodiments, the bank reconciliation process compares the dollar value and number of debit transactions, and the dollar value and number of credit transactions. Based on this comparison, transactions from bank statement 124 are matched to transactions from the general ledger (e.g., where dollar amounts are equal).

In some embodiments, the matches may be provided with a confidence level score. The confidence level score, for example, may be based on how well the transactions from bank statement 124 matched with the transactions from the general ledger. In some embodiments, if the match is perfect (e.g., there is no discrepancy in dollar amount, date of transaction, payee/payor information), then the confidence level score may be a perfect score (e.g., 100, 10, or some other indicator).

Matches that have some discrepancy may be given a lower score. In some embodiments, each category (dollar amount, date of transaction, payee/payor information) may make up some portion of the confidence level score. In some embodiments, one or more of the categories represent a binary “yes” or “no” on whether that category is a match. In some embodiments, one or more of the categories may receive its own score on a scale (e.g., how close are the transaction dates). Each category may be weighted differently. For example, the dollar amount may be given more weight than the date of transaction since a check may take some time to be deposited. In some embodiments, the confidence level score must be above some threshold before a match will be determined.

In some embodiments, each individual match may be provided with a confidence level score. In some embodiments, the overall bank reconciliation may be provided with a confidence level score. For example, the overall bank reconciliation confidence level score may be an average of the confidence level scores for each individual match. In some embodiments, the confidence level score(s) may be provided to users (e.g., at entity electronic device 130). A user may review the matches and confidence level scores and provide feedback to server 110 over network 140. In some embodiments, server 110 may use the feedback to update its approach to confidence level scoring through machine learning (e.g., by adjusting weights to different categories, how to score each category, adjusting factors for each category (e.g., range of dates to consider for date of transaction), etc.). Other approaches to confidence level scoring may be used. An additional example of confidence level scoring that may be used is provided below.

Additional steps of method 300 will now be described with reference to FIG. 4B. In some embodiments, after the transactions have been compared and matched at operation 350, the matched transactions may be aggregated into total matched debits and total matched credits at operation 352. In some embodiments, the total matched debits may include a total dollar amount of matched debits for the period. In some embodiments, the total matched debits may include a total number of matched debit transactions. Similarly, in some embodiments, the total matched credits may include a total dollar amount of matched credits for the period. In some embodiments, the total matched credits may include a total number of matched credit transactions.

In some embodiments, there may be unmatched transactions as part of method 300. An unmatched transaction in the accounting system (stored at server 110) is a valid situation. For example, a check written in January may not clear until March. As another example, a check deposited on the last day of the month may not post at the bank until the next month. These transactions, in some embodiments, may be noted for future bank reconciliations so they can be matched when the bank records have a corresponding transaction. A transaction at the bank, however, that is not in the accounting system would result in an unbalanced reconciliation and would be output as an exception. This transaction could be a bank error, or it could be a transaction that has not been recorded in the accounting system.

In some embodiments, the total number of matched transactions (credit and debit) may be used to determine the confidence level score for the overall bank reconciliation (e.g., by comparing it to the number of transactions in the general ledger and/or the number of transactions from the bank statement 124). For example, the closer the number of matches, the number of transactions in the general ledger, and the number of transactions from the bank statement are to being equal, the higher the confidence level score may be.

In some embodiments, the total matched debits and the total matched credits may be used at operation 354 to determine a matched-based ending balance. In some embodiments, a starting balance is determined for the period being reconciled. The starting balance may be an ending balance from a prior reconciliation period. For example, server 110 may retrieve an ending balance from a previous bank reconciliation record (e.g., for the period immediately preceding the period being reconciled). The dollar amount of total matched credits may be added to and the dollar amount of total matched debits may be subtracted from the starting balance to result in the matched-based ending balance.

In some embodiments, once the matched-based ending balance is determined, it may be compared at operation 356 with the bank statement ending balance (retrieved at operation 330). If the matched-based ending balance is equal to the bank statement ending balance, this indicates that the period has been reconciled. If the matched-based ending balance is not equal to the bank statement ending balance, then the period has not been reconciled because there is a discrepancy that needs to be resolved.

In some embodiments, at operation 360 a bank reconciliation record is created regardless of whether the ending balances are equal. The bank reconciliation record may be created from the data discussed above, including the starting balance (which may be an ending balance from a prior reconciliation period), the bank statement ending balance, total matched debits, and total matched credits. Creating a bank reconciliation record, even if it is not reconciled, has a benefit in that it provides visibility to accounting operations that need to be performed, thus increasing financial reliability.

In some embodiments, if the ending balances are equal, the bank reconciliation record may be automatically posted at operation 362. Posting the bank reconciliation record is an indication that the reconciliation is complete, and the account has been reconciled. The bank reconciliation record may be saved, for example, at server 110 (e.g., at bank reconciliation module 114 and/or general ledger module 112). In some embodiments, after the bank reconciliation record has posted, a notification may be sent to entity electronic device 130 at operation 364. In some embodiments, the notification indicates whether the matched-based ending balance is equal to the ending balance from bank statement 124. The notification may inform a user that the bank reconciliation record has been automatically matched and posted (and that reconciliation is complete). As noted above, this process may be performed based on multiple bank accounts of the entity. If all bank accounts of the entity were successfully automatically posted at operation 362, then the notification sent at operation 364 will indicate that, and operation 364 may conclude method 300 until the next period is ready to be reconciled.

In some embodiments, if the ending balances are not equal in the created bank reconciliation record from operation 360, then a notification may be sent to entity electronic device 130 at operation 366. In some embodiments, the notification indicates whether the matched-based ending balance is equal to the ending balance from bank statement 124. The notification may inform a user that the bank reconciliation record has not been posted. While operation 366 is shown as a separate step from operation 364, in some embodiments, a single notification is provided. For example, if an entity has multiple accounts that are being reconciled, a notification may be sent to an entity electronic device 130 (operation 364/366) that lists all the bank reconciliation records that were automatically created at operation 360. The list may show which of those were automatically matched and posted (e.g., operation 364) and which of those were not automatically matched and remain unposted (e.g., operation 366).

In some embodiments, at operation 370, user input may be received. For example, a user may review the bank reconciliation record that was not matched/posted to identify what kept the accounts from being reconciled. The user may then enter instructions/feedback at entity electronic device 130, which may be sent over network 140 to server 110 to complete the reconciliation. This may include matching transactions that server 110 was unable to automatically match, identifying errors in the general ledger, identifying errors in bank records, and/or identifying open items (e.g., a check that has not been deposited).

In some embodiments, based on the user input, method 300 would proceed to one or more of operations 372, 374, 376, and 378. If the only user input was to match transactions that server 110 was unable to automatically match, the bank reconciliation record may be updated to reflect this change, and then check at operation 378 whether the discrepancy is resolved. If the discrepancy is resolved, method 300 would proceed to operation 362, at which point the updated bank reconciliation record would be posted (followed by a notification being sent to entity electronic device 130 at operation 364). If the discrepancy had not been entirely resolved, method 300 would return to operation 366 with a notification 366 to entity electronic device 130, allowing for further follow up by the user until the discrepancy is entirely resolved.

If the user input included identifying open items, the bank reconciliation record may be updated based on those open items at operation 372. If the user input included identifying an error in the bank records, a notification may be sent to the bank (e.g., bank server 120) at operation 374. In some embodiments, the notification sent to the bank may also or alternatively alert the bank of fraudulent activity using the bank account. If the user input included identifying an error in the general ledger, the general ledger may be corrected at operation 376. After any issues have been addressed at operations 372, 374, 376, method 300 may proceed to operation 378 to ensure the discrepancy has been entirely resolved (as discussed above).

In some embodiments, a user may select whether to enable automatic posting. For example, entity electronic device 130 may be configured to receive user input to enable automatic posting of bank reconciliation records. If automatic posting is enabled, method 300 would follow the process shown in FIG. 4B. If automatic posting is not enabled, after operation 360, method 300 would proceed to operation 366 for all accounts, input would be received at operation 370 (which may include the same input discussed above, or if there are no issues to resolve, the input may simply be instruction to post the bank reconciliation record (e.g., by clicking a post button)), operations 372, 374, and 376 would be completed (as needed), operation 378 would ensure that the period was reconciled, and then the bank reconciliation record would be posted at operation 362. Other variations may also be implemented.

The methods and systems disclosed herein allow for a large number of reconciliations to be performed. In some instances, a single management company may manage hundreds or even thousands of associations, and each of these associations may themselves include a handful to tens of associations. As a result, for one large management company, the process described herein can automatically reconcile tens of thousands of bank accounts. For a mega management company with hundreds of management company branches, this number could be in the hundreds of thousands.

A more specific example of the bank reconciliation process according to some embodiments is set forth below. Steps 1-15 relate generally to a matching aspect of the bank reconciliation process and steps 16-21 relate generally to a reconciliation aspect.
Step 1: The bank statement end date is retrieved from the bank (e.g., from bank statement 124). The end date is typically the last business day of the month.
Step 2: The bank statement start date is calculated. The start date may be calculated from the ending date of the last reconciled bank statement and adding one day.
Step 3: For each bank account number for the company, a list of all bank transactions on the bank statement are retrieved. This may come from the BAI2 file or equivalent (e.g., daily transaction information 122) where the bank transaction date is between the start and end date determined in steps 1 and 2. Step 3.a: At this stage, a statement starting balance is taken from the reconciled ending balance of the prior period. In addition, the starting balance is also taken from the first of the bank transactions for the reconciliation period, if it exists, and compared with the statement starting balance. These two starting balances must match to perform the reconciliation process. If they do not, an error is noted (e.g., for user follow up) and the bank account is not reconciled. Step 3.b: In addition to the statement starting balance, the statement ending balance is taken from the last bank transaction in the list.
Step 4: For each corresponding bank account, a list is obtained and/or created of all accounting general ledger transactions that were not previously reconciled (which may be designated with a flag) that have a transaction date less than or equal to the ending date of the bank statement determined in step 1.
Step 5: The transactions in the list determined in step 4 are gone through and for each record it is determined if the general ledger transaction is a check or not.
Step 6: If the general ledger transaction is a check, the check number, dollar amount, and check date are retrieved from the general ledger. At this point, the bank transactions determined in step 3 are searched and an exact match is performed based on check number and dollar amount.
Step 7: If the general ledger transaction is not a check, several levels of matching are performed, going from most specific to general depending on the available data in the bank transactions. Step 7.a: A list is created of bank transactions that have a bank transaction date within +/−0 days of the accounting transaction date (i.e., the date is the same). As discussed below, this range is expanded in later steps. For example, an accounting transaction of February 15 can match to a bank transaction recorded as February 13-February 17, which accounts for delays in posting both the general ledger transaction and the bank transaction. Step 7.b: From the list of bank transactions determined in step 7.a, a match for the general ledger transaction at issue is looked for in the following order: (i) a match based on dollar amount, reference number, and payee name (this results in a Confidence Level of 1); (ii) a match based on dollar amount and reference number (this results in a Confidence Level of 2); and (iii) a match based on dollar amount (this results in a Confidence Level of 3)
Step 8: If the transaction is matched, the bank transaction is flagged as matched, so it is not matched against another transaction. The accounting transaction is also marked as matched.
Step 9: The above matching represents the first pass through the list of transactions from step 4. Steps 5-8 are repeated for unmatched transactions, with the date range being widened in each pass to +/−1 day, then +/−2 days, and then +/−3 days.
Step 10: If there are still unmatched transactions from step 4, the process looks for more complex matches. Specifically, groupings of bank transactions may be compared to individual accounting transactions. The following process may be used for each unmatched transaction. Step 10.a: A list is created of groupings of bank transactions that have a bank transaction date within +/−0 days of the accounting transaction date (i.e., the date is the same). As discussed below, this range is expanded in later steps. For example, an accounting transaction of February 15 can match to a bank transaction recorded as February 13-February 17, which accounts for delays in posting both the general ledger transaction and the bank transactions. Step 10.b: From the list of grouped bank transactions determined in step 10.a, a grouped match for the general ledger transaction at issue is looked for in the following order: (i) a grouped match based on dollar amount, reference number, and payee name compared to grouped bank account data (this results in a Confidence Level of 1); (ii) a grouped match based on dollar amount and reference number compared to grouped bank account data (this results in a Confidence Level of 2); and (iii) a grouped match based on dollar amount compared to grouped bank account data (this results in a Confidence Level of 3). Advanced logic and machine learning may be used as the system uses patterns (e.g., patterns identified over time) to determine if one accounting transaction matches against grouped (i.e., multiple) bank transactions.
Step 11: Step 10 is repeated for unmatched transactions, with the date range being widened in each pass to +/−1 day, then +/−2 days, and then +/−3 days.
Step 12: If there are still unmatched transactions from step 4, the process looks for more complex matches. Specifically, groupings of accounting transactions may be compared to individual bank transactions. The following process may be used for each unmatched transaction.
Step 12.a: A list is created of groupings of accounting transactions that have an accounting transaction date within +/−0 days of the bank transaction date (i.e., the date is the same). As discussed below, this range is expanded in later steps. For example, a bank transaction of February 15 can match to accounting transactions recorded as February 13-February 17, which accounts for delays in posting both the general ledger transactions and the bank transaction. Step 12.b: From the list of grouped accounting transactions determined in step 12.a, a grouped match for the bank transaction at issue is looked for in the following order: (i) a grouped match based on dollar amount, reference number, and payee name compared to grouped general ledger accounting data (this results in a Confidence Level of 1); (ii) a grouped match based on dollar amount and reference number compared to grouped general ledger accounting data (this results in a Confidence Level of 2); and (iii) a grouped match based on dollar amount compared to grouped general ledger accounting data (this results in a Confidence Level of 3). Advanced logic and machine learning may be used as the system uses patterns (e.g., patterns identified over time) to determine if one bank transaction matches against grouped (i.e., multiple) accounting transactions.
Step 13: Step 12 is repeated for unmatched transactions, with the date range being widened in each pass to +/−1 day, then +/−2 days, and then +/−3 days.
Step 14: At this point, the matching process is completed. The system keeps the following totals for each bank account: a. Number and dollar amount of matched accounting debit transactions; b. Number and dollar amount of matched accounting credit transactions; c. Number and dollar amount of matched bank debit transactions; d. Number and dollar amount of matched bank credit transactions; e. Number and dollar amount of unmatched bank debit transactions; and f. Number and dollar amount of unmatched bank credit transactions.
Step 15: Bank interest added during the period is retrieved from the bank transactions. Different banks have different mechanisms for identifying interest. In addition, not all bank accounts pay interest. Step 15.a: A corresponding general ledger entry is created if this interest does not yet exist in the general ledger as an automated entry. Step 15.b: If the automated interest general ledger entry already exists, the amount is compared to ensure it has not changed. If it has changed, an error is indicated and the bank reconciliation will not auto-reconcile as the bank interest has been tampered with.

At this point, the matching portion of the bank reconciliation process is completed and the process proceeds to a reconciliation portion of the bank reconciliation process.
Step 16: TotalAmountDebit is calculated as step 14a.
Step 17: TotalAmountCredit is calculated as step 14b.
Step 18: The total general ledger activity is calculated as TotalAmountDebit TotalAmountCredit.
Step 19: The reconciled general ledger balance is calculated as the statement starting balance (from step 3a) plus (TotalAmountCredit-TotalAmountDebit).
Step 20: The ReconciledDifference is calculated as the statement ending balance (from step 3b)-the reconciled general ledger balance (from step 19).
Step 21: If the ReconciledDifference is zero this means the bank statement is reconciled. However, in order to post, several additional checks are performed. Step 21.a: TotalAmountDebit calculated in step 14a is compared with matched bank credits calculated in step 14d to see if they are equal. A bank credit represents an increase in the bank balance so this corresponds to a balance sheet debit which increases the asset balance. Step 21.b: TotalAmountCredit calculated in step 14b is compared with matched bank debits calculated in step 14cto see if they are equal. A bank debit represents a decrease in the bank balance so this corresponds to a balance sheet credit which decreases the asset balance. Step 21.c: The following checks are also performed but only impact the confidence score, not posting: (i) Number of accounting debits calculated in step 15a is compared to the number of matched bank credits calculated in step 15d to see if they are equal; and (ii) Number of accounting credits calculated in step 15b is compared to the number of matched bank debits calculated in step 15c to see if they are equal.

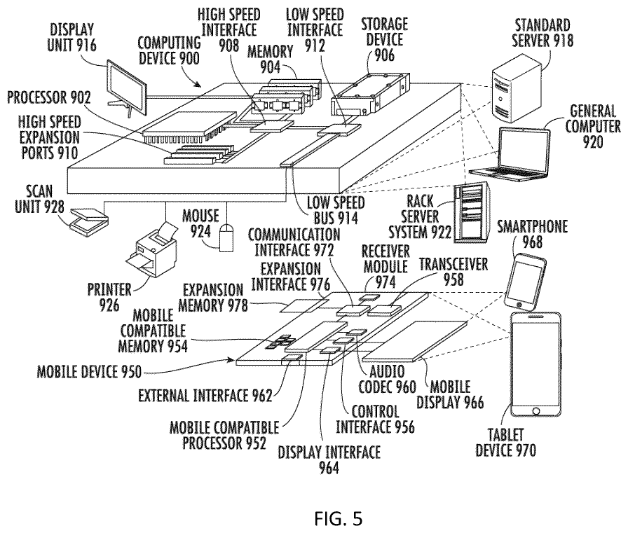

As discussed above, the systems and methods disclosed herein may be partially or fully implemented with a computer through software running on or associated with the computer, or an application accessible by the computer or some other electronic device. As one example, FIG. 5 is a schematic diagram of specific computing device 900 and a specific mobile computing device 950 that can be used to perform and/or implement any of the embodiments disclosed herein.

The specific computing device 900 may represent various forms of digital computers, such as laptops, desktops, workstations, personal digital assistants, servers, blade servers, mainframes, and/or other appropriate computers. The specific mobile computing device 950 may represent various forms of mobile devices, such as smartphones, camera phones, personal digital assistants, cellular telephones, and other similar mobile devices. The components shown here, their connections, couples, and relationships, and their functions, are meant to be exemplary only, and are not meant to limit the embodiments described and/or claimed, according to one embodiment.

The specific computing device 900 may include a processor 902, a memory 904, a storage device 906, a high-speed interface 908 coupled to the memory 904 and a plurality of high-speed expansion ports 910, and a low-speed interface 912 coupled to a low-speed bus 914 and a storage device 906. In one embodiment, each of the components heretofore may be inter-coupled using various buses, and may be mounted on a common motherboard and/or in other manners as appropriate. The processor 902 may process instructions for execution in the specific computing device 900, including instructions stored in the memory 904 and/or on the storage device 906 to display a graphical information for a GUI on an external input/output device, such as a display unit 916 coupled to the high-speed interface 908, according to one embodiment.

In other embodiments, multiple processors and/or multiple buses may be used, as appropriate, along with multiple memories and/or types of memory. Also, a plurality of specific computing devices 900 may be coupled together, with each device providing portions of the necessary operations (e.g., as a server bank, a group of blade servers, and/or a multi-processor system). In some embodiments, hosted and/or virtual servers may be used (such as Amazon Web Services or Azure).

The memory 904 may be coupled to the specific computing device 900. In one embodiment, the memory 904 may be a volatile memory. In another embodiment, the memory 904 may be a non-volatile memory. The memory 904 may also be another form of computer-readable medium, such as a magnetic and/or an optical disk. The storage device 906 may be capable of providing mass storage for the specific computing device 900. In one embodiment, the storage device 906 may be a floppy disk device, a hard disk device, an optical disk device, a tape device, a flash memory and/or other similar solid state memory device. In another embodiment, the storage device 906 may be an array of the devices in a computer-readable medium previously mentioned heretofore, including devices in a storage area network and/or other configurations.

A computer program may be comprised of instructions that, when executed, perform one or more methods, such as those described above. The instructions may be stored in the memory 904, the storage device 906, a memory coupled to the processor 902, and/or a propagated signal.

The high-speed interface 908 may manage bandwidth-intensive operations for the specific computing device 900, while the low-speed interface 912 may manage lower bandwidth-intensive operations. Such allocation of functions is exemplary only. In one embodiment, the high-speed interface 908 may be coupled to the memory 904, the display unit 916 (e.g., through a graphics processor and/or an accelerator), and to the plurality of high-speed expansion ports 910, which may accept various expansion cards.

In the embodiment, the low-speed interface 912 may be coupled to the storage device 906 and the low-speed bus 914. The low-speed bus 914 may be comprised of a wired and/or wireless communication port (e.g., a Universal Serial Bus (“USB”), a Bluetooth® port, an Ethernet port, and/or a wireless Ethernet port). The low-speed bus 914 may also be coupled to the scan unit 928, a printer 926, a keyboard, a mouse 924, and a networking device (e.g., a switch and/or a router) through a network adapter.

The specific computing device 900 may be implemented in a number of different forms, as shown in the figure. In one embodiment, the specific computing device 900 may be implemented as a standard server 918 and/or a group of such servers. In another embodiment, the specific computing device 900 may be implemented as part of a rack server system 922. In yet another embodiment, the specific computing device 900 may be implemented as a general computer 920 such as a laptop or desktop computer. Alternatively, a component from the specific computing device 900 may be combined with another component in a specific mobile computing device 950. In one or more embodiments, an entire system may be made up of a plurality of specific computing device 900 and/or a plurality of specific computing device 900 coupled to a plurality of specific mobile computing device 950.

In one embodiment, the specific mobile computing device 950 may include a mobile compatible processor 952, a mobile compatible memory 954, and an input/output device such as a mobile display 966, a communication interface 972, and a transceiver 958, among other components. The specific mobile computing device 950 may also be provided with a storage device, such as a microdrive or other device, to provide additional storage. In one embodiment, the components indicated heretofore are inter-coupled using various buses, and several of the components may be mounted on a common motherboard.

The mobile compatible processor 952 may execute instructions in the specific mobile computing device 950, including instructions stored in the mobile compatible memory 954. The mobile compatible processor 952 may be implemented as a chipset of chips that include separate and multiple analog and digital processors. The mobile compatible processor 952 may provide, for example, for coordination of the other components of the specific mobile computing device 950, such as control of user interfaces, applications run by the specific mobile computing device 950, and wireless communication by the specific mobile computing device 950.

The mobile compatible processor 952 may communicate with a user through the control interface 956 and the display interface 964 coupled to a mobile display 966. In one embodiment, the mobile display 966 may be a Thin-Film-Transistor Liquid Crystal Display (“TFT LCD”), an Organic Light Emitting Diode (“OLED”) display, and another appropriate display technology. The display interface 964 may comprise appropriate circuitry for driving the mobile display 966 to present graphical and other information to a user. The control interface 956 may receive commands from a user and convert them for submission to the mobile compatible processor 952.

In addition, an external interface 962 may be in communication with the mobile compatible processor 952, so as to enable near area communication of the specific mobile computing device 950 with other devices. External interface 962 may provide, for example, for wired communication in some embodiments, or for wireless communication in other embodiments, and multiple interfaces may also be used.

The mobile compatible memory 954 may be coupled to the specific mobile computing device 950. The mobile compatible memory 954 may be implemented as a volatile memory and a non-volatile memory. The expansion memory 978 may also be coupled to the specific mobile computing device 950 through the expansion interface 976, which may comprise, for example, a Single In Line Memory Module (“SIMM”) card interface. The expansion memory 978 may provide extra storage space for the specific mobile computing device 950, or may also store an application or other information for the specific mobile computing device 950.

Specifically, the expansion memory 978 may comprise instructions to carry out the processes described above. The expansion memory 978 may also comprise secure information. For example, the expansion memory 978 may be provided as a security module for the specific mobile computing device 950, and may be programmed with instructions that permit secure use of the specific mobile computing device 950. In addition, a secure application may be provided on the SIMM card, along with additional information, such as placing identifying information on the SIMM card in a non-hackable manner.

The mobile compatible memory may include a volatile memory (e.g., a flash memory) and a non-volatile memory (e.g., a non-volatile random-access memory (“NVRAM”)). In one embodiment, a computer program comprises a set of instructions that, when executed, perform one or more methods. The set of instructions may be stored on the mobile compatible memory 954, the expansion memory 978, a memory coupled to the mobile compatible processor 952, and a propagated signal that may be received, for example, over the transceiver 958 and/or the external interface 962.

The specific mobile computing device 950 may communicate wirelessly through the communication interface 972, which may be comprised of a digital signal processing circuitry. The communication interface 972 may provide for communications using various modes and/or protocols, such as a Global System for Mobile Communications (“GSM”) protocol, a Short Message Service (“SMS”) protocol, an Enhanced Messaging System (“EMS”) protocol, a Multimedia Messaging Service (“MMS”) protocol, a Code Division Multiple Access (“CDMA”) protocol, Time Division Multiple Access (“TDMA”) protocol, a Personal Digital Cellular (“PDC”) protocol, a Wideband Code Division Multiple Access (“WCDMA”) protocol, a CDMA2000 protocol, and a General Packet Radio Service (“GPRS”) protocol.

Such communication may occur, for example, through the transceiver 958 (e.g., radio-frequency transceiver). In addition, short-range communication may occur, such as using a Bluetooth®, Wi-Fi, and/or other such transceiver. In addition, a GPS (“Global Positioning System”) receiver module 974 may provide additional navigation-related and location-related wireless data to the specific mobile computing device 950, which may be used as appropriate by a software application running on the specific mobile computing device 950.

The specific mobile computing device 950 may also communicate audibly using an audio codec 960, which may receive spoken information from a user and convert it to usable digital information. The audio codec 960 may likewise generate audible sound for a user, such as through a speaker (e.g., in a handset smartphone of the specific mobile computing device 950). Such a sound may comprise a sound from a voice telephone call, a recorded sound (e.g., a voice message, a music files, etc.) and may also include a sound generated by an application operating on the specific mobile computing device 950.

The specific mobile computing device 950 may be implemented in a number of different forms, as shown in the figure. In one embodiment, the specific mobile computing device 950 may be implemented as a smartphone 968. In another embodiment, the specific mobile computing device 950 may be implemented as a personal digital assistant (“PDA”). In yet another embodiment, the specific mobile computing device, 950 may be implemented as a tablet device 970.

Various embodiments of the systems and techniques described here can be realized in a digital electronic circuitry, an integrated circuitry, a specially designed application specific integrated circuits (“ASICs”), a piece of computer hardware, a firmware, a software application, and a combination thereof. These various embodiments can include embodiment in one or more computer programs that are executable and/or interpretable on a programmable system including one programmable processor, which may be special or general purpose, coupled to receive data and instructions from, and to transmit data and instructions to, a storage system, one input device, and at least one output device.

These computer programs (also known as programs, software, software applications, and/or code) comprise machine-readable instructions for a programmable processor, and can be implemented in a high-level procedural and/or object-oriented programming language, and/or in assembly/machine language. As used herein, the terms “machine-readable medium” and/or “computer-readable medium” refers to any computer program product, apparatus and/or device (e.g., magnetic discs, optical disks, memory, and/or Programmable Logic Devices (“PLDs”)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here may be implemented on a computing device having a display device (e.g., a cathode ray tube (“CRT”) and/or liquid crystal (“LCD”) monitor) for displaying information to the user and a keyboard and a mouse by which the user can provide input to the computer. Other kinds of devices can be used to provide for interaction with a user as well; for example, feedback provided to the user can be any form of sensory feedback (e.g., visual feedback, auditory feedback, and/or tactile feedback) and input from the user can be received in any form, including acoustic, speech, and/or tactile input.

The systems and techniques described here may be implemented in a computing system that includes a back end component (e.g., as a data server), a middleware component (e.g., an application server), a front end component (e.g., a client computer having a graphical user interface, and/or a Web browser through which a user can interact with an embodiment of the systems and techniques described here), and a combination thereof. The components of the system may also be coupled through a communication network.

The communication network may include a local area network (“LAN”) and a wide area network (“WAN”) (e.g., the Internet). The computing system can include a client and a server. In one embodiment, the client and the server are remote from each other and interact through the communication network.

Many additional implementations are possible. Further implementations are within the CLAIMS.

It will be understood that implementations of the automatic bank reconciliation systems and methods include but are not limited to the specific components disclosed herein, as virtually any components consistent with the intended operation of various automatic bank reconciliation systems and methods may be utilized. Accordingly, for example, it should be understood that, while the drawings and accompanying text show and describe particular automatic bank reconciliation systems and methods implementations, any such implementation may comprise any shape, size, style, type, model, version, class, grade, measurement, concentration, material, weight, quantity, and/or the like consistent with the intended operation of automatic bank reconciliation systems and methods.

The concepts disclosed herein are not limited to the specific automatic bank reconciliation systems and methods shown herein. In places where the description above refers to particular implementations of automatic bank reconciliation systems and methods, it should be readily apparent that a number of modifications may be made without departing from the spirit thereof and that these implementations may be applied to other implementations disclosed or undisclosed. The presently disclosed automatic bank reconciliation systems and methods are, therefore, to be considered in all respects as illustrative and not restrictive.

1. A method of automated bank reconciliation of a reconciliation period for an entity by a server of a computer network, the method comprising:
during the reconciliation period, daily receiving, at the server, transaction information from a bank over a network, wherein the transaction information is associated with an account of the entity at the bank;
matching the transaction information with accounting transactions on a general ledger of the entity stored in the memory on the server;
storing the transaction information received daily in a first data structure in the memory on the server, wherein each transaction in the first data structure includes a timestamp indicating when the transaction information was received at the server;
at an end of the reconciliation period, receiving, at the server, a bank statement from the bank over the network, wherein the bank statement is associated with the account of the entity at the bank and is associated with the reconciliation period;
in response to receiving the bank statement, retrieving a statement ending date and an ending balance on the statement ending date from the bank statement;
accessing, from the memory, all transactions from the bank statement associated with the reconciliation period;
comparing the transactions from the bank statement with the transaction information stored in the first data structure to detect discrepancies indicating post-receipt manipulation of the transaction information, wherein the comparing comprises: (i) comparing transaction amounts, transaction dates, and transaction types between the bank statement and the first data structure, and (ii) verifying that the transaction information in the first data structure has not been altered after the timestamp;
determining, based on the comparing, whether a discrepancy exists between the transactions from the bank statement and the transaction information stored in the first data structure, wherein the discrepancy indicates that the transaction information in the first data structure was altered after being received from the bank;
in the case that it is determined that a discrepancy exists, sending a first notification to an entity electronic device over the computer network, wherein the first notification indicates that a manipulation of the transaction information received daily has occurred;
in the case that it is determined that a discrepancy does not exist, accessing from the memory all accounting transactions from the general ledger of the entity associated with the reconciliation period;
comparing the transactions from the bank statement with the accounting transactions from the general ledger of the entity and matching transactions from the bank statement to accounting transactions from the general ledger of the entity, wherein the matching comprises determining a confidence level score for each potential match based on a weighted comparison of a plurality of transaction attributes including at least a dollar amount, a date of transaction, and a payee, and wherein a match is determined when the confidence level score exceeds a threshold;
aggregating the matched transactions into total matched debits and total matched credits, wherein the total matched debits comprises a dollar amount and a number of matched debit transactions, and wherein the total matched credits comprises a dollar amount and a number of matched credit transactions;
determining a matched-based ending balance by adding the dollar amount of the total matched credits to and subtracting the dollar amount of the total matched debits from a bank reconciliation starting balance, wherein the bank reconciliation starting balance is an ending balance from a prior reconciliation period;
comparing the matched-based ending balance with the ending balance from the bank statement;
creating a bank reconciliation record comprising the bank reconciliation starting balance, the total matched debits, the total matched credits, the match-based ending balance, and the ending balance from the bank statement;
automatically posting the bank reconciliation record if the matched-based ending balance is equal to the ending balance from the bank statement; and
sending a second notification to the entity electronic device over the computer network, wherein the second notification indicates whether the bank reconciliation record has been matched and posted.

2. The method of claim 1, further comprising, before retrieving the statement ending date and the ending balance on the statement ending date from the bank statement, checking whether reconciliation for the reconciliation period has already been completed.

3. The method of claim 1, further comprising, before retrieving the statement ending date and the ending balance on the statement ending date from the bank statement, checking whether reconciliation for a prior reconciliation period has already been completed.

4. The method of claim 1, further comprising identifying offsetting entries in the general ledger and clearing the identified offsetting entries.

5. The method of claim 1, further comprising identifying interest credited by the bank and creating an interest journal entry in the general ledger.

6. The method of claim 1, wherein the network comprises the internet.

7. The method of claim 1, further comprising receiving user input over the network from the entity electronic device if the matched-based ending balance is not equal to the ending balance from the bank statement.

8. A method of automated bank reconciliation of a reconciliation period for an entity by a server of a computer network, the method comprising:
receiving a bank statement from a bank, wherein the bank statement is associated with an account of the entity at the bank;
in response to receiving the bank statement, retrieving a statement ending date and an ending balance on the statement ending date from the bank statement;
accessing transaction information received daily during the reconciliation period from a first data structure stored in memory on a server, wherein each transaction in the first data structure includes a timestamp indicating when the transaction information was received at the server;
comparing the transactions from the bank statement with the transaction information stored in the first data structure to detect discrepancies indicating post-receipt manipulation of the transaction information, wherein the comparing comprises: (i) comparing transaction amounts, transaction dates, and transaction types between the bank statement and the first data structure, and (ii) verifying that the transaction information in the first data structure has not been altered after the timestamp;
determining, based on the comparing, whether a discrepancy exists between the transactions from the bank statement and the transaction information stored in the first data structure, wherein the discrepancy indicates that the transaction information in the first data structure was altered after being received from the bank;
in the case that it is determined that a discrepancy exists, sending a first notification to an entity electronic device over the computer network, wherein the first notification indicates that a manipulation of the transaction information received daily has occurred;
in the case that it is determined that a discrepancy does not exist, accessing from the memory all accounting transactions from the general ledger of the entity associated with the reconciliation period;
matching transactions from the bank statement stored in memory on the server and associated with the reconciliation period to accounting transactions from a general ledger of the entity stored in the memory and associated with the reconciliation period, wherein the matching comprises determining a confidence level score for each potential match based on a weighted comparison of a plurality of transaction attributes including at least a dollar amount, a date of transaction, and a payee, and wherein a match is determined when the confidence level score exceeds a threshold;
aggregating the matched transactions into total matched debits and total matched credits;
determining a matched-based ending balance by adding the total matched credits to and subtracting the total matched debits from a bank reconciliation starting balance, wherein the bank reconciliation starting balance is an ending balance from a prior reconciliation period;
comparing the matched-based ending balance with the ending balance on the statement ending date;
creating a bank reconciliation record comprising the bank reconciliation starting balance, the total matched debits, the total matched credits, the match-based ending balance, and the ending balance on the statement ending date; and
sending a second notification to an entity electronic device over the computer network, wherein the second notification indicates whether the matched-based ending balance is equal to the ending balance on the statement ending date.

9. The method of claim 8, further comprising checking whether reconciliation for the reconciliation period has already been completed.

10. The method of claim 8, further comprising checking whether reconciliation for a prior reconciliation period has already been completed.

11. The method of claim 8, further comprising identifying offsetting entries in the general ledger and clearing the identified offsetting entries.

12. The method of claim 8, further comprising identifying interest credited by the bank and creating an interest journal entry in the general ledger.

13. The method of claim 8, further comprising automatically posting the bank reconciliation record if the matched-based ending balance is equal to the ending balance on the statement ending date.

14. The method of claim 8, further comprising receiving user input over the network from the entity electronic device if the matched-based ending balance is not equal to the ending balance on the statement ending date.

15. A system for automated bank reconciliation of a reconciliation period for an entity, the system comprising:
a bank reconciliation server configured to store a general ledger of the entity;
a server associated with a bank, the bank reconciliation server configured to communicate with the bank server over a network; and
an entity electronic device operably connected to the bank reconciliation server over the network,
wherein the bank reconciliation server is configured to:
receive a bank statement from the bank over the network, wherein the bank statement is associated with an account of the entity at the bank;
in response to receiving the bank statement, retrieve a statement ending date and an ending balance on the statement ending date from the bank statement;
access, from memory of the server, all transactions from the bank statement associated with the reconciliation period;
access transaction information received daily during the reconciliation period from a first data structure stored in the memory of the server, wherein each transaction in the first data structure includes a timestamp indicating when the transaction information was received at the server;
compare the transactions from the bank statement with the transaction information stored in the first data structure to detect discrepancies indicating post-receipt manipulation of the transaction information, wherein the comparing comprises: (i) comparing transaction amounts, transaction dates, and transaction types between the bank statement and the first data structure, and (ii) verifying that the transaction information in the first data structure has not been altered after the timestamp;
determine, based on the comparing, whether a discrepancy exists between the transactions from the bank statement stored and the transaction information stored in the first data structure, wherein the discrepancy indicates that the transaction information in the first data structure was altered after being received from the bank;
in the case that it is determined that a discrepancy exists, send a first notification to the entity electronic device over the computer network, wherein the first notification indicates that a manipulation of the transaction information received daily has occurred;
in the case that it is determined that a discrepancy does not exist, access from the memory all accounting transactions from the general ledger of the entity associated with the reconciliation period;
compare the transactions from the bank statement with the accounting transactions from the general ledger of the entity and match transactions from the bank statement to accounting transactions from the general ledger of the entity, wherein the matching comprises determining a confidence level score for each potential match based on a weighted comparison of a plurality of transaction attributes including at least a dollar amount, a date of transaction, and a payee, and wherein a match is determined when the confidence level score exceeds a threshold;
aggregate the matched transactions into total matched debits and total matched credits, wherein the total matched debits comprises a dollar amount and a number of matched debit transactions, and wherein the total matched credits comprises a dollar amount and a number of matched credit transactions;
determine a matched-based ending balance by adding the dollar amount of the total matched credits to and subtracting the dollar amount of the total matched debits from a bank reconciliation starting balance, wherein the bank reconciliation starting balance is an ending balance from a prior reconciliation period;
compare the matched-based ending balance with the ending balance from the bank statement;
create a bank reconciliation record comprising the bank reconciliation starting balance, the total matched debits, the total matched credits, the match-based ending balance, and the ending balance from the bank statement;
send a second notification to the entity electronic device over the network, wherein the second notification indicates whether the bank reconciliation record has been matched and posted.

16. The system of claim 15, wherein the entity electronic device is configured to receive user input to enable automatic posting of the bank reconciliation record.

17. The system of claim 16, wherein the bank reconciliation server is configured to automatically post the bank reconciliation record if the matched-based ending balance is equal to the ending balance from the bank statement, when automatic posting is enabled.

18. The system of claim 15, wherein the entity electronic device is configured to receive user input if the matched-based ending balance is not equal to the ending balance from the bank statement.

19. The system of claim 15, wherein the bank reconciliation server is configured to check whether reconciliation for a prior reconciliation period has already been completed.

20. The system of claim 15, wherein the network comprises the internet.
